(19) United States
(12) Patent Application Publication
(10) Pub. No.: US 2018/0108209 A1
(43) Pub. Date: Apr. 19, 2018

(54) MODULAR WAGERING ELECTRONIC GAME MACHINE

(71) Applicants: Paul Barker, (US); ECLIPSE GAMING SYSTEMS, Duluth, GA (US)

(72) Inventors: Boris L. Amegadjie, Deer Park, IL (US); Paul Barker, Chicago, IL (US)

(73) Assignees: ECLIPSE GAMING SYSTEMS, Duluth, GA (US); Paul Barker, Chicago, IL (US)

(21) Appl. No.: 15/782,773

(22) Filed: Oct. 12, 2017

Related U.S. Application Data
(60) Provisional application No. 62/483,859, filed on Apr. 10, 2017.
(60) Provisional application No. 62/407,050, filed on Oct. 12, 2016.

(51) Int. Cl. G07F 17/32

(52) U.S. Cl. CPC G07F 17/3216; G07F 17/3209; G07F 17/3211

(57) ABSTRACT

A modular gaming system can be constructed from a standard base cabinet including a plurality of support members and an interchangeable upper modular cabinet holding one or more display monitors, wherein the upper modular cabinet is attached to the standard base cabinet. The standard base cabinet can have an attached door for accessing gaming system components. The upper modular cabinet can have a member for holding the one or more display monitors either vertically or horizontally, and may include a pivotally attached door. The standard base cabinet and the upper modular cabinet can have lighted wrapped front and side panels including lighting units. The lighting units can include light emitting diodes (LEDs).

### CLAIM OF PRIORITY

This application claims priority from U.S. Provisional Application No. 62/407,050, filed Oct. 12, 2016, and U.S. Provisional Application No. 62/483,859, filed Apr. 10, 2017, each of which is incorporated by reference in its entirety.

### FIELD OF THE INVENTION

The invention relates to an electronic gaming machine.

### BACKGROUND OF THE INVENTION

Gaming is one of the most profitable entertainment industries in the world. Gaming machines such as slots and video poker became the most heavily trafficked casino games having a large impact on business. Since the commercial birth of gaming, casinos, bars, shopping malls, hotels, chain restaurants, and bowling alleys around the world have been installing gaming machines to capitalize on the potential profits.

However, the gaming industry has made a significant shift since the explosion of the Internet and computer processor technology. Since the advent of personal computers and gaming consoles, home gaming and mobile video games have taken over the market. Casino operators wishing to attract younger patrons are looking to video games to attract these younger players. Millennials, for example, desire special display monitors with crisp graphics and quick response times for the best gaming experiences.

Some casinos and resorts are slow to replace older games and have instead steadily upgraded other amenities with the unintended consequence of further reducing the gaming traffic. While other casino operators are making steps to upgrade visual displays, introducing plasma screens and themed cabinets based on television shows and films, the technology has stayed the same. Thus, there is a need for game machine manufacturers and casino operators to configure game machines in a way that mirrors the emotional demand of mobile video games and consoles, while offering versatility and reducing the cost involved in replacing game machines as technology advances.

### SUMMARY

Briefly, and in general terms, various embodiments are directed to a modular gaming system that can be constructed from a base cabinet including a plurality of support members, a replaceable upper modular cabinet or unit configured to hold one or more display monitors, and footrest extending from a lower portion of the base cabinet. The support members of the base cabinet can include at least a front face member, a back face member, a first side face member, and a second side face member. The base cabinet can house gaming system components. The base cabinet can further include a door that moves between an open position and a closed position for accessing the gaming system components. The door of the base cabinet can further house user gaming interface components.

The upper modular cabinet can be attached at a seam to a top end of the base cabinet. The upper modular cabinet can be configured to hold at least one display monitor. The upper modular cabinet can include a pivot for pivotally attaching a door to the upper modular cabinet. The door of the upper modular cabinet can be configured to hold the at least one display monitor. The door of the upper modular cabinet can be configured to move about the pivot between an open position and a closed position. The door of the upper modular cabinet can provide user viewing access to the at least one display monitor.

Other features and advantages will become apparent from the following detailed description, taken in conjunction with the accompanying drawings, which illustrate by way of example, the features of the various embodiments.

### BRIEF DESCRIPTION OF THE DRAWING

FIGS. 1A and 1B are block diagrams of a perspective view of one embodiment of a modular gaming system.

FIGS. 2A and 2B illustrate perspective views of one embodiment of a base cabinet of the modular gaming system.

FIGS. 3A and 3B illustrate perspective views of one embodiment of a modular gaming system having a touchscreen table top configuration.

FIGS. 4A and 4B illustrate the modular design of the modular gaming system illustrated in FIGS. 3A and 3B, respectively.

FIGS. 5A and 5B illustrate perspective views of the modular gaming system illustrated in FIGS. 3A and 3B.

FIGS. 6A, 6B, and 6C illustrate perspective views of another embodiment of the modular gaming system illustrated in FIGS. 3A and 3B, including lighting panels.

FIGS. 7A and 7B illustrate perspective views of one embodiment of a modular gaming system having an upper modular cabinet with a single display monitor.

FIGS. 8A and 8B illustrate the modular design of the modular gaming system illustrated in FIGS. 7A and 7B.

FIGS. 9A and 9B illustrate perspective views of one embodiment of a modular gaming system having an upper modular cabinet with a single display monitor, including lighting panels.

FIGS. 10A and 10B illustrate perspective views of one embodiment of a modular gaming system having an upper modular cabinet with dual display monitors.

FIGS. 11A and 11B illustrate the modular design of the modular gaming system illustrated in FIGS. 10A and 10B.

FIGS. 12A and 12B illustrate perspective views of one embodiment of a modular gaming system having an upper modular cabinet with dual display monitors, including lighting panels.

FIG. 13 illustrates a vertical lift of a door of the upper modular cabinet of one embodiment of a modular gaming system.

FIGS. 14A and 14B illustrate perspective views of one embodiment of a modular gaming system having an upper modular cabinet with a curved display monitor.

FIGS. 15A and 15B illustrate the modular design of the modular gaming system illustrated in FIGS. 14A and 14B.

FIGS. 16A and 16B illustrate perspective views of one embodiment of a modular gaming system having an upper modular cabinet with a curved display monitor, including lighting panels.

FIG. 17 illustrates one embodiment of a mounting configuration for display monitors housed by an upper modular cabinet of the modular gaming system.

FIG. 18 illustrates an exemplary embodiment of a modular gaming system.

FIG. 19 illustrates a perspective view of one embodiment of a modular gaming system of FIG. 18.

FIG. 20 illustrates another perspective view of one embodiment of a modular gaming system of FIG. 18.

### DETAILED DESCRIPTION

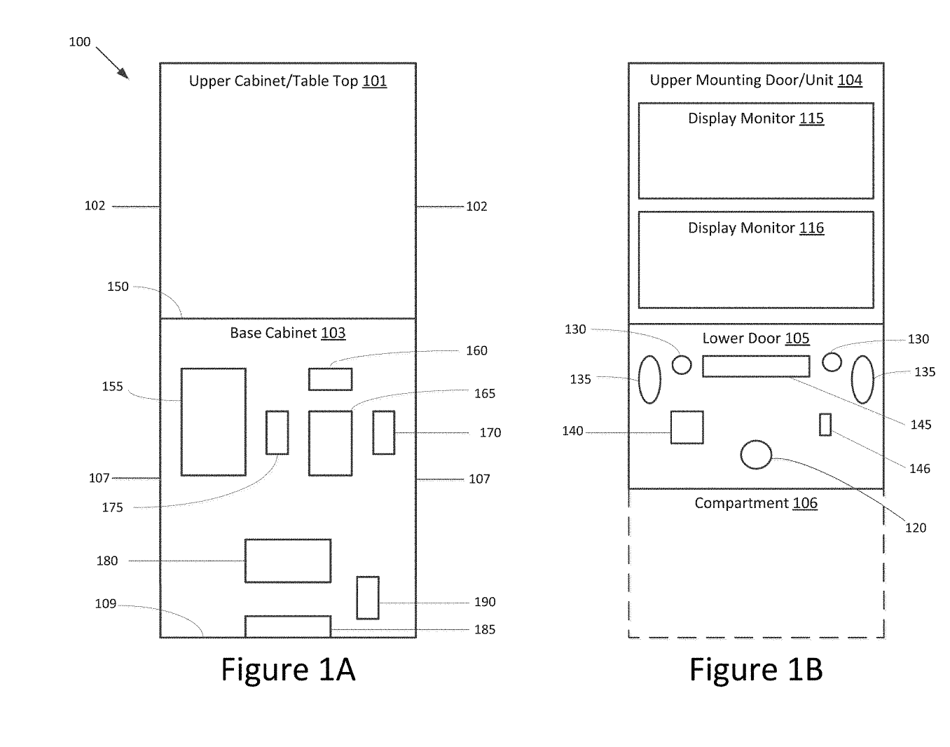

A game cabinet system can have a modular and interchangeable design. The design has a number of advantages, as described below. In a preferred embodiment, a modular wagering game cabinet or modular gaming system 100 includes at least one base cabinet 103 and an upper modular unit 101 (e.g. an upper cabinet 101 or table top 101), as shown in FIGS. 1A and 1B. In a preferred embodiment, the base cabinet 103 houses all the standard gaming system components and user interface components, except any electronic display monitors for displaying a game. In a preferred embodiment, the upper modular unit 101 is modular and interchangeable between several configurations for holding the electronic display monitors, including a plurality of cabinet configurations and a table top configuration.

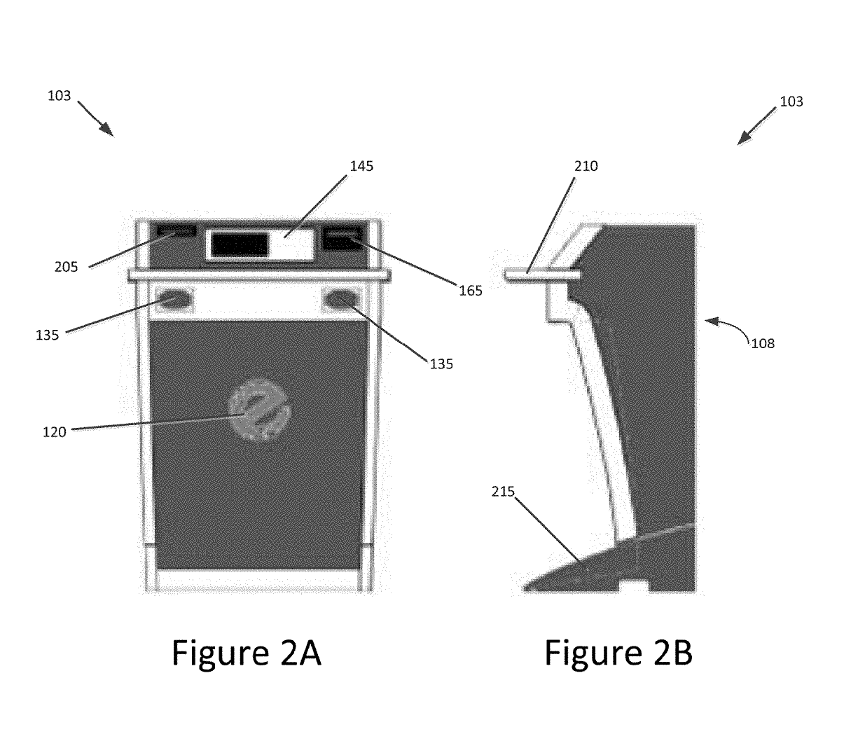

A base cabinet 103 is constructed from a plurality of support members. The support members of the base cabinet 103 include front face members 105 and 106, a back face member 108 (as illustrated in FIG. 2B), right and left side face members 107, a floor member 109, and a top member (or seam) 150. The support members of base cabinet 103 may be connected to form an enclosed cabinet 103. The members of both the base cabinet 103 and upper unit 101 may have at least one of an exterior cabinet finish including a powder coat, a vinyl wrap, a magnetic wrap, and a color. A back plate may be configured to cover the back face member 108. The base cabinet 103 may further include a cabinet back lit panel.

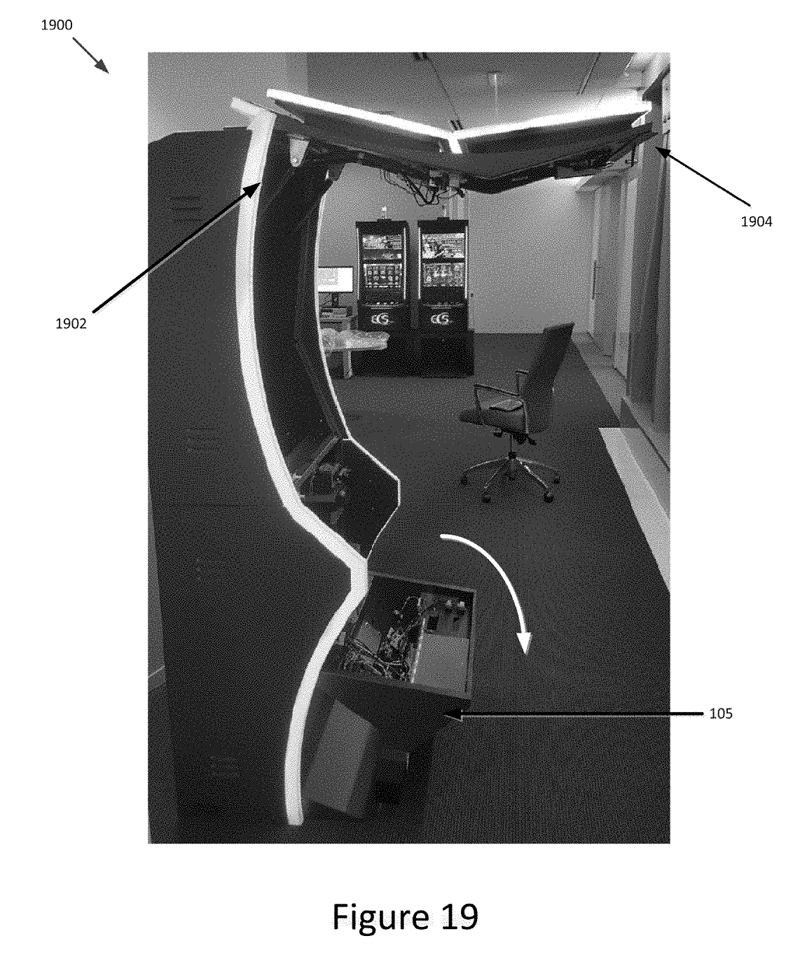

In a preferred embodiment, the front face member 105 is a door to base cabinet 103 that provides access to gaming system components housed in an interior space of the base cabinet 103. The door 105 may be moved between an open position and a closed position to provide or limit access to the interior space of the base cabinet 103. The base cabinet 103 includes a pivot or hinge attached to base cabinet 103 at a bottom portion of door 105 for pivotally attaching door 105 to base cabinet 103. Door 105 of the base cabinet 103 is configured to move about the pivot between an open position and a closed position in a vertical direction (as illustrated in FIG. 19). In one embodiment, front face member 106 is a lower portion of door 105. In another embodiment, front face member 106 is an additional compartment 106 that does not open or close with door 105.

In one embodiment as illustrated in FIGS. 1A and 1B, the gaming system components may include a central processing unit (CPU) 155, a 12 volt power supply 175, and multiple 24 volt power supplies 170 and 190, a bill acceptor 165, a printer 160, a subwoofer 180, a battery backup 185, memory, etc. The door 105 of base cabinet 103 may further house and provide access to additional gaming system components including user interface components. These additional gaming system components may include mechanical buttons 130, audio speakers 135, an audio amplifier 140, a video button panel 145, a light emitting diodes (LED) controller 146, and a logo plate 120. In one embodiment, the user interface components may be operable and accessible to a user when the door 105 is in a closed position. In another embodiment, the user interface components may not be operable when door 105 is in an open position. In some embodiments, gaming system components are accessible for tuning, maintenance, repair, or replacement when door 105 is in an open position.

Base cabinet 103 may be built to any of several heights. In some embodiments, base cabinet 103 may have a height of about 16 to 45 inches, for example, about 16 inches, about 21 inches, or about 37 inches. In other embodiments, base cabinet 103 may be one-half the standard height of 60 to 75 inches. It is contemplated that in some embodiments of modular gaming system 100, not all gaming system components, e.g. subwoofer 180 or a battery backup 185, may be housed in the interior space of the base cabinet 103, e.g. where the height of cabinet 103 is less than the height. In these embodiments, gaming system components such as subwoofer 180 and/or battery backup 185 may be placed in a common platform structure provided by a casino or other gaming facility.

FIGS. 2A and 2B illustrate perspective views of one embodiment of base cabinet 103 of modular gaming system 100, according to a preferred embodiment of present invention. FIG. 2A is a front view of base cabinet 103. FIG. 2B is an example side view of base cabinet 103. As illustrated in FIGS. 2A and 2B, base cabinet 103 may also include a horizontal surface 210, a player tracking device 205, and a cushioned footrest 215.

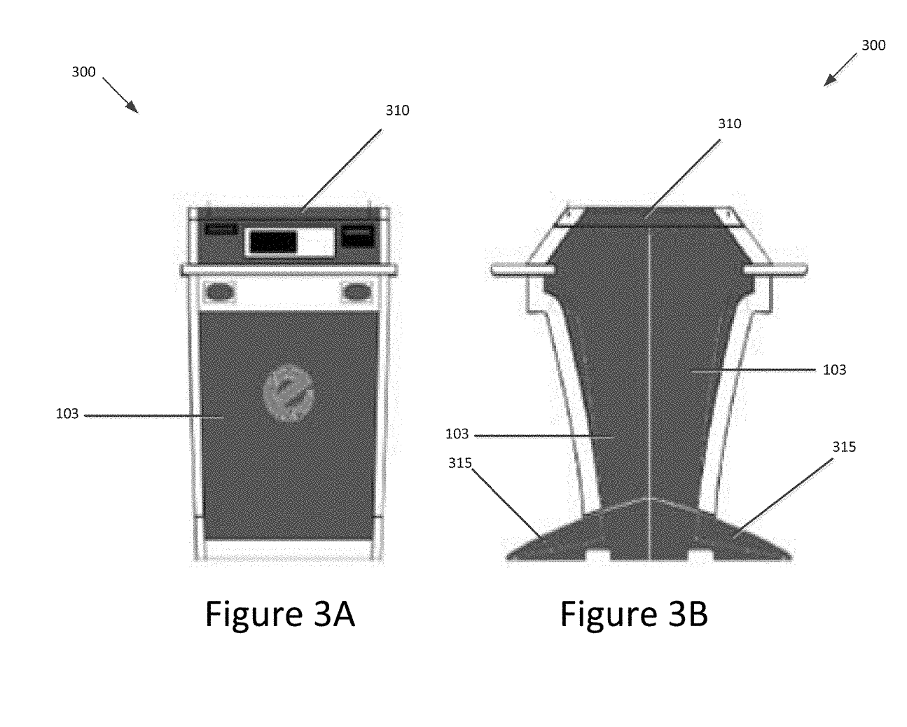

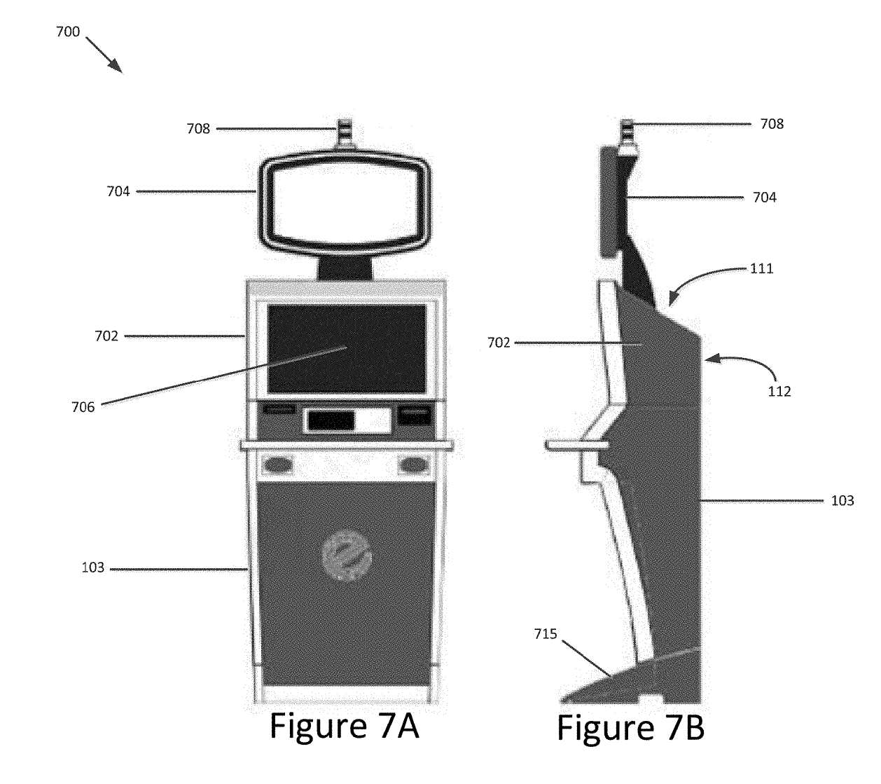

In FIG. 1A, the modular gaming cabinet and system 100 also includes an upper modular unit 101. The upper modular unit 101 sits above and may be attached by bolting or otherwise fastening upper modular unit 101 at seam 150 to base cabinet 103. In one embodiment, the upper modular unit 101 is configured as a cabinet and placed above base cabinet 103 in a vertical position (as illustrated in FIGS. 7A-20). In another embodiment, the upper modular unit 101 is configured as a table top and placed above base cabinet 103 in a horizontal position (as illustrated in FIGS. 3A-6C). In a preferred embodiment, the upper modular unit 101 is constructed of one or more support members and is configured to hold one or more display units 115 and 116 of the gaming system 100.

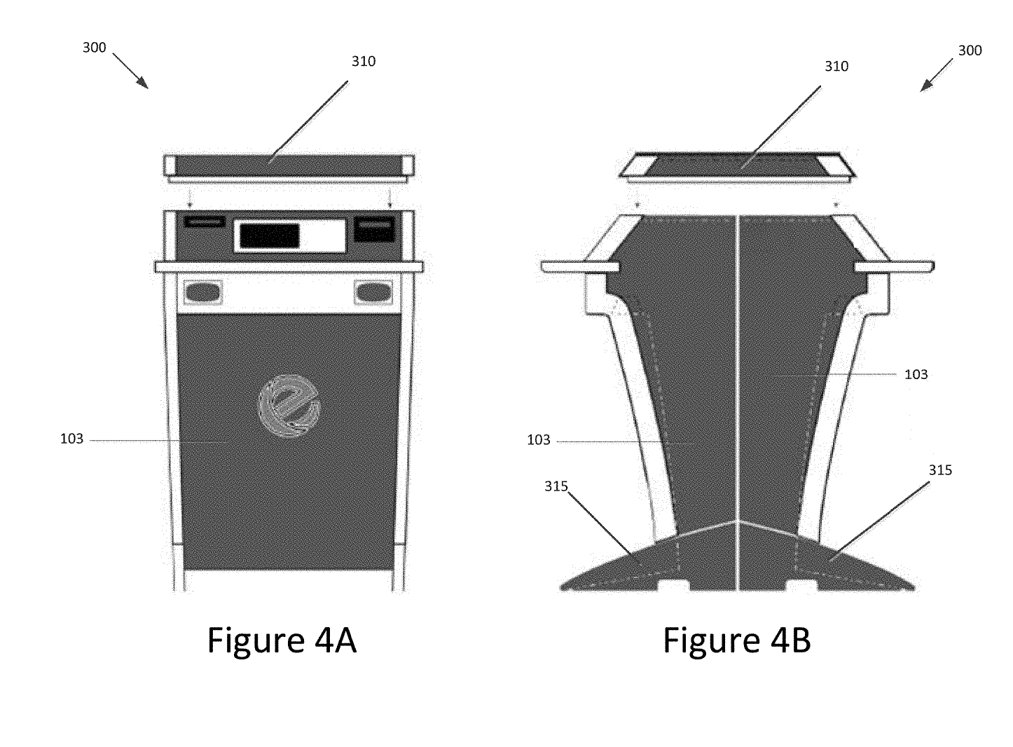

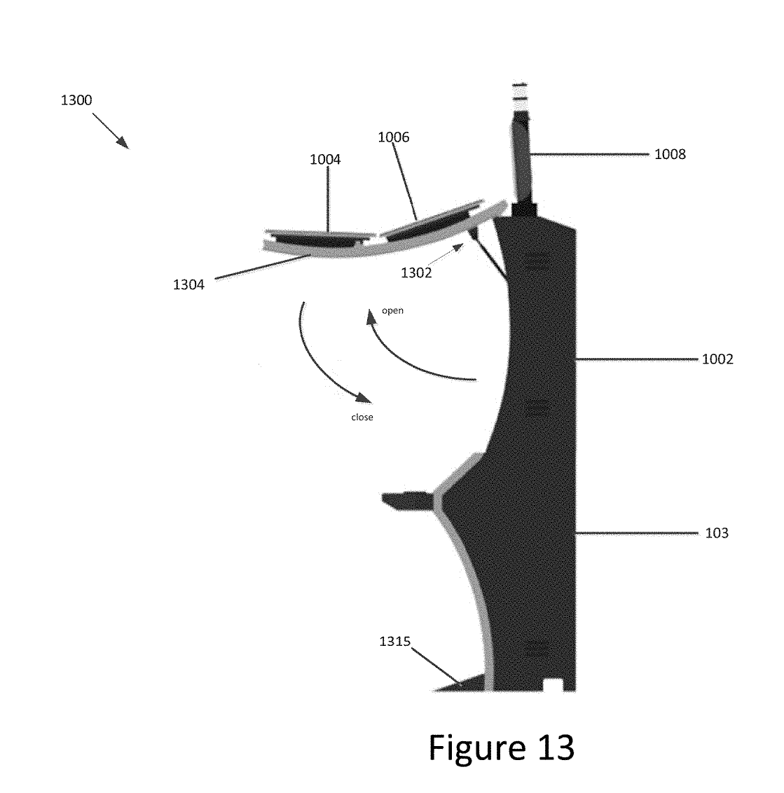

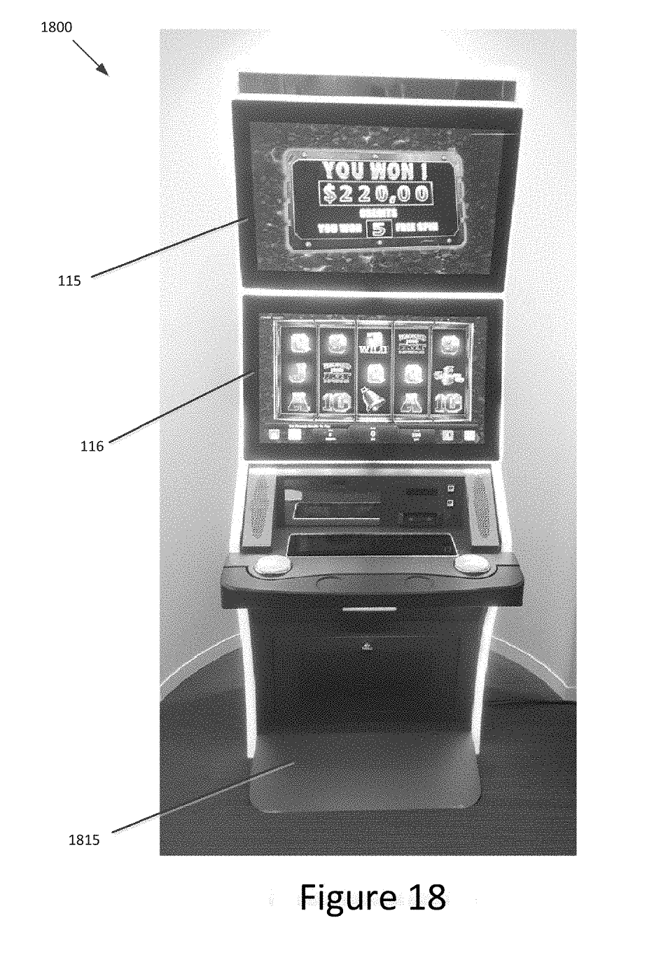

The display units 115 and 116 may be any electronic means for displaying video game information to a player or user of modular game system 100 (as illustrated in FIG. 18). For example, display unit 115 or 116 may be a display monitor or screen such as a computer monitor, a game monitor, a television monitor, a liquid crystal display (LCD) monitor, a light-emitting diodes (LEDs) monitor, an in-plane switching display (IPS) monitor, a high-definition (HD) display monitor, etc. (as illustrated in FIG. 18). In one embodiment, one or more display units 115 and 116 may be mounted to upper mounting door 104 of an upper cabinet 101 using a mounting bracket 1702 constructed into the door 104. The door 104, e.g. door 1304 (as illustrated in FIG. 13), may vertically hold one or more display units 115 and 116 when the door is in a closed position. In another embodiment, the upper modular unit 101 is a table top 101, e.g. table top 310 (as illustrated in FIGS. 3A-3B and 4A-4B), for horizontally holding one or more display units 115 and 116 on an upper mounting unit 104, instead of a door 104.

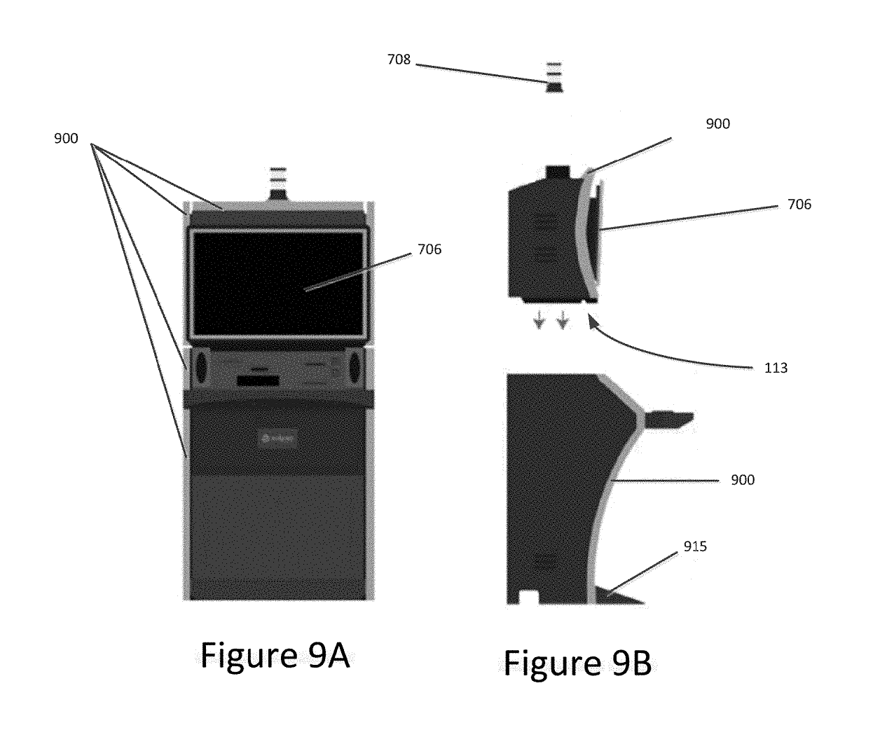

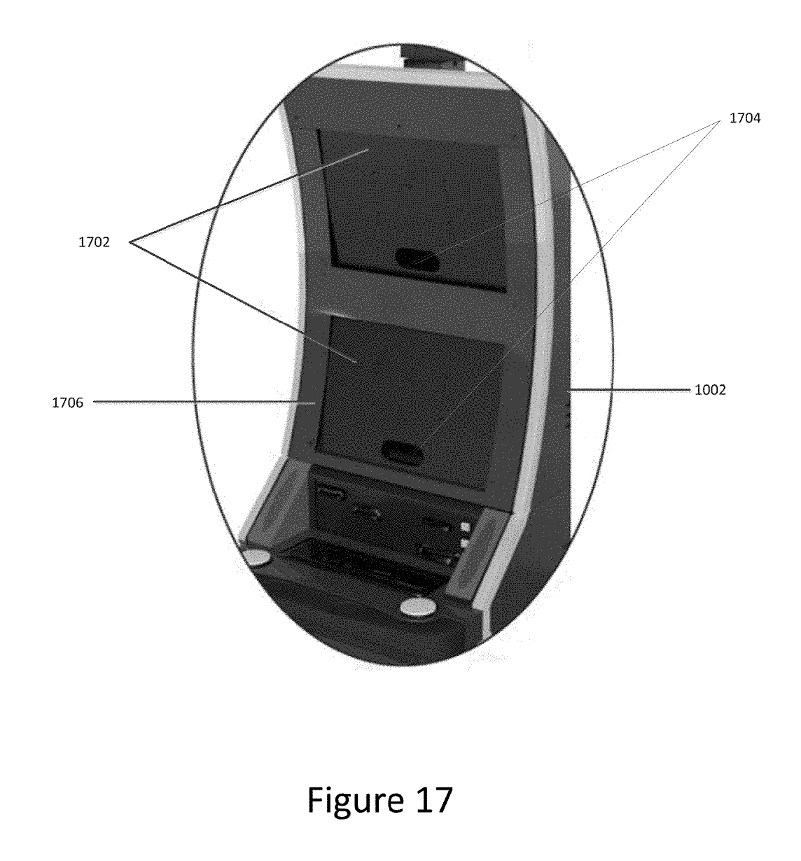

In one embodiment, upper modular unit 101 is a cabinet 101 and is constructed of a plurality of support members. The support members of the upper modular cabinet 101 may include, for example, a front face member or door 104, a back face member 112 (as illustrated in FIG. 7B), right and left side face members 102, a top member 111 (as illustrated in FIG. 7B), and a bottom member 113 (as illustrated in FIG. 9B). The support members of upper modular cabinet 101 may be connected to form an enclosed cabinet 101. In a preferred embodiment, front face member 104 is a door 104 to upper modular cabinet 101 that houses electrical wiring or cords stemming from the display monitors 115 and 116 and fed into the interior housing of cabinet 101 through access holes 1704 (as illustrated in FIG. 17).

In a preferred embodiment, the door 104 of upper modular cabinet 101 may be moved between an open position and a closed position to provide or limit access to the interior space of the cabinet 101. In a preferred embodiment, upper modular cabinet 101 includes a pivot 1302 (as illustrated in FIG. 13). Pivot 1302 is configured to pivotally attach upper door 104, e.g. door 1304, to upper modular cabinet 101, e.g. 1002, and facilitate the opening and closing of door 104 in a vertical direction (as shown in FIGS. 13 and 19). For example, a user may lift door 1304 or 1904 in an upward vertical direction (as shown in FIGS. 13 and 19) to access the interior space of upper modular cabinet 1002 (as shown in FIG. 13). The user may pull down door 1304 in a downward vertical direction (as shown in FIG. 13) to close the upper modular cabinet 1002. In some embodiments, the door 104 or 1304 may be electronically controlled to lift and close. For example, an operator or user may press an external button or touchscreen to cause the door 104 to open or close. FIG. 13 illustrates a vertical lift of a door 1304 of the upper modular cabinet 1002 of the modular gaming system 1300, according to one embodiment of the present invention.

In another embodiment, modular gaming system 100 is formed into a table top gaming configuration 300 using e.g. an upper table top 101, instead of an upper cabinet 101. In this embodiment, upper table top 101 is constructed of a single support member 104 that holds one or more display units 115 and 116 to form a table top, e.g. table top 310 (as illustrated in FIGS. 3A-5B). FIGS. 3A and 3B illustrate perspective views of one embodiment of modular gaming system 300 constructed from at least one touchscreen table top 310 and two (2) base cabinets 103. The touchscreen may face in an upward direction for the table top configuration 300. FIG. 3A illustrates a front view of modular gaming system 300 having a touch screen table top configuration. FIG. 3B illustrates a side view of modular gaming system 300 having a touch screen table top configuration. FIGS. 4A and 4B depict the modularity of modular gaming system 300 illustrated in FIGS. 3A and 3B, respectively. As shown in FIGS. 4A and 4B, one or more table tops 310, i.e. upper mounting units 104, may be attached to base cabinets 103 to build modular gaming system 300 having a touch screen table top configuration.

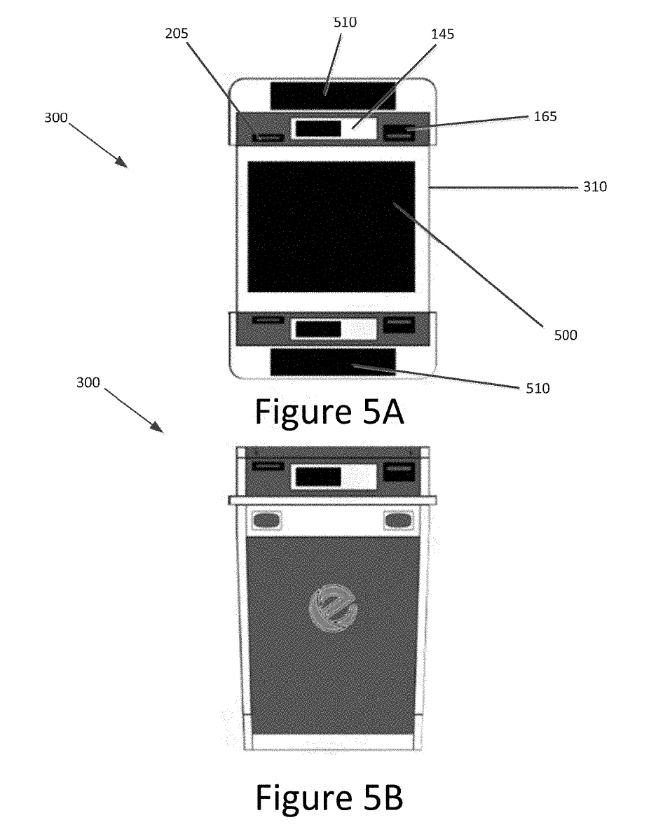

FIGS. 5A and 5B illustrate perspective views of the modular gaming system illustrated in FIGS. 3A and 3B. FIG. 5A illustrates an example top view of modular gaming system 300 having at least one touchscreen display monitor 500 and two button deck LCDs 510, according to one embodiment of the modular gaming system 100 having a touch screen table top configuration. In this embodiment, modular gaming system 300 may optionally include a custom multi-touch monitor 500 with red, green, blue (RGB) color changing LED surround lights and 16.4 inch button deck LCDs 510.

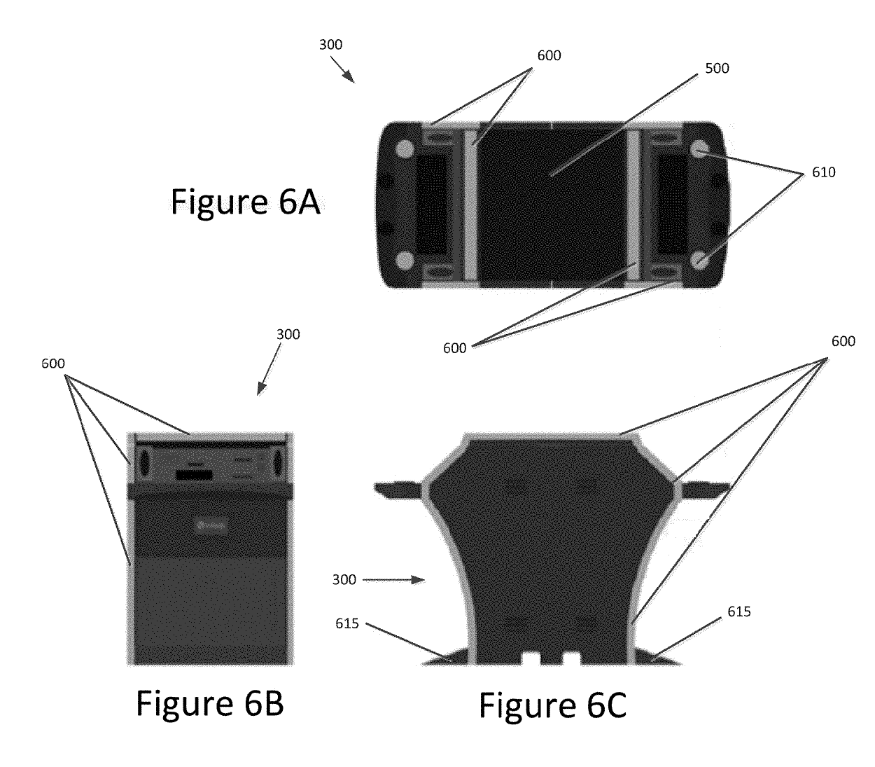

FIGS. 6A, 6B, and 6C illustrate perspective views of another embodiment of the modular gaming system illustrated in FIGS. 3A and 3B. FIG. 6A illustrates an example top view of modular gaming system 300 having a touchscreen display monitor 500, according to another embodiment of modular gaming system 100 having a touch screen table top configuration. In this embodiment, modular gaming system 300 may optionally include “repeat bet” buttons 610. As shown in FIGS. 6A, 6B, and 6C, modular gaming system 300, including e.g. a base unit 103 and an upper unit 101, may also include lighted, wrapped front and side panels 600 including lighting units. The lighting units can include light emitting diodes (LEDs).

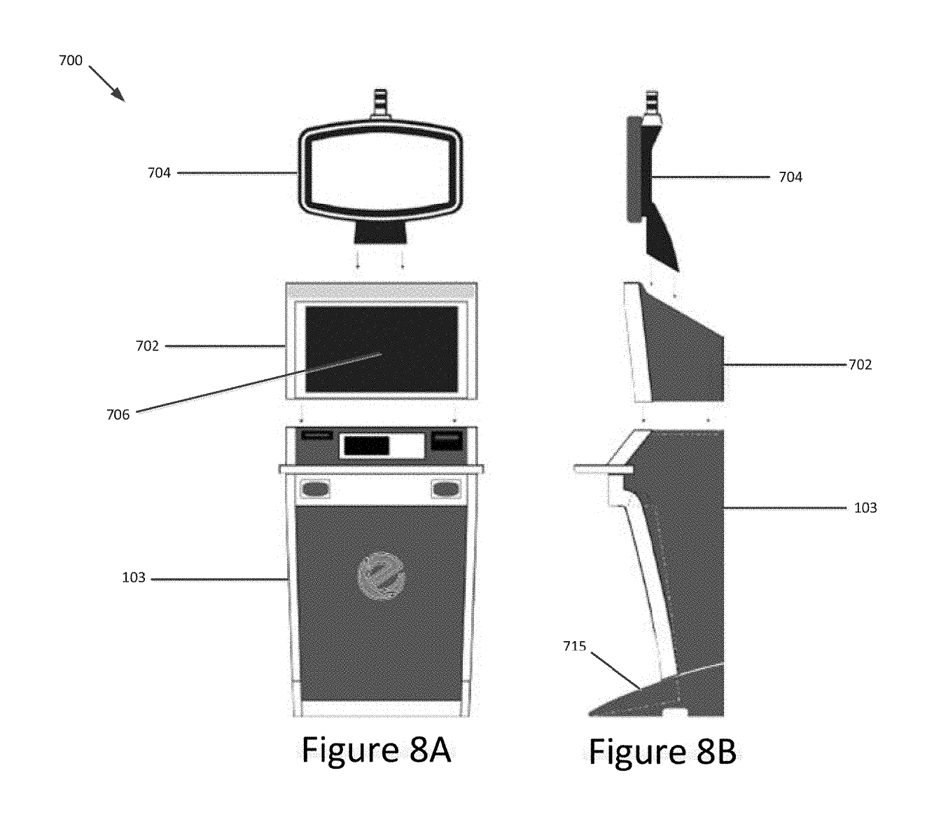

According to another aspect, upper units 101 (i.e. upper cabinets 101 and table tops 101) are interchangeable. The upper units 101 are individually constructed to hold a different number, size, and configuration of display units 115 and/or 116 of modular gaming system 100. For example, each upper cabinet style 101 may have a different number, size, and configuration of monitors (as illustrated in FIGS. 7A-20). FIGS. 7A and 7B illustrate perspective views of one embodiment of the modular gaming system having an upper modular cabinet 702 with a single display monitor 706. As seen in FIGS. 7A and 7B, upper cabinet 702 may support an LED backlit 704 and sensor 708. In one example LED backlit 704 is a 21 inch LED backlit full HD video topper with chasing RGB LEDs. FIGS. 8A and 8B illustrate the modularity of modular gaming system 700 depicted in FIGS. 7A and 7B. As seen in FIGS. 8A and 8B, an upper cabinet 702 may be mounted onto a base cabinet 103, and an LED backlit 704 may be mounted onto the upper cabinet 702. In some embodiments of the modular gaming system having an upper modular cabinet 702 with a single display monitor 706, the LED backlit 704 is an optional component (as illustrated in FIGS. 9A and 9B). FIGS. 9A and 9B illustrate perspective views of a modular gaming system 100 having an upper modular cabinet with a single display monitor 706, according to another embodiment of the present invention, including lighting panels 900.

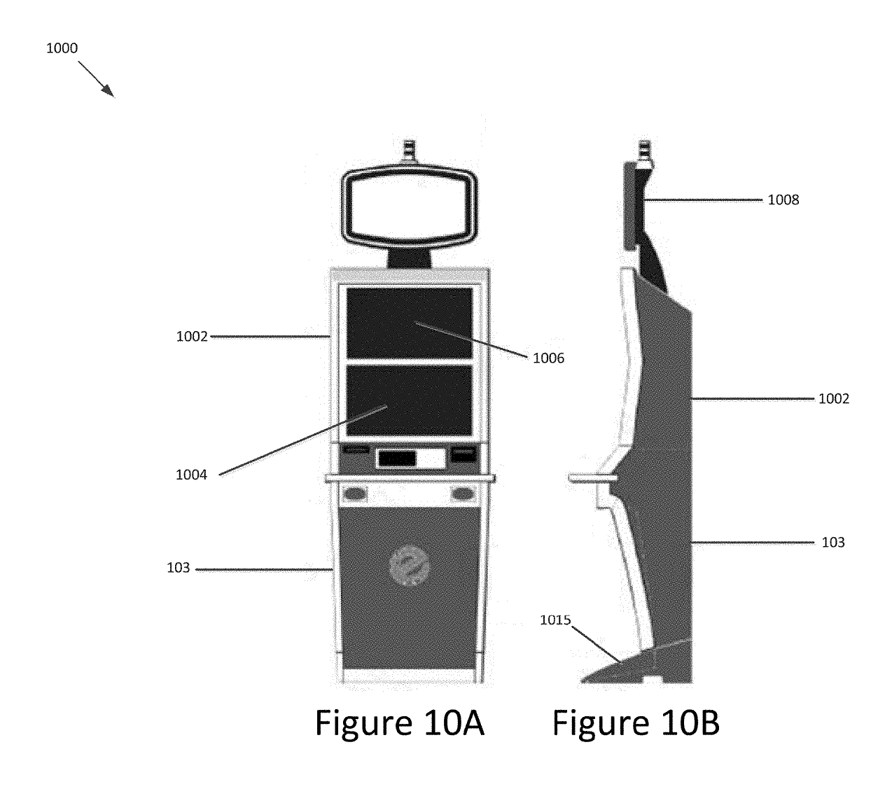

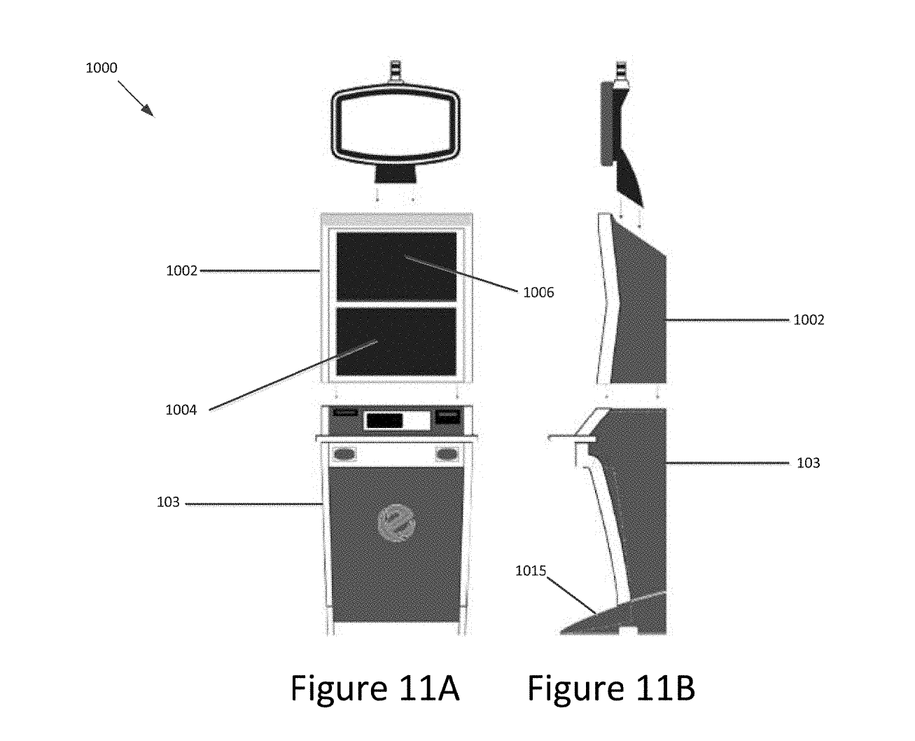

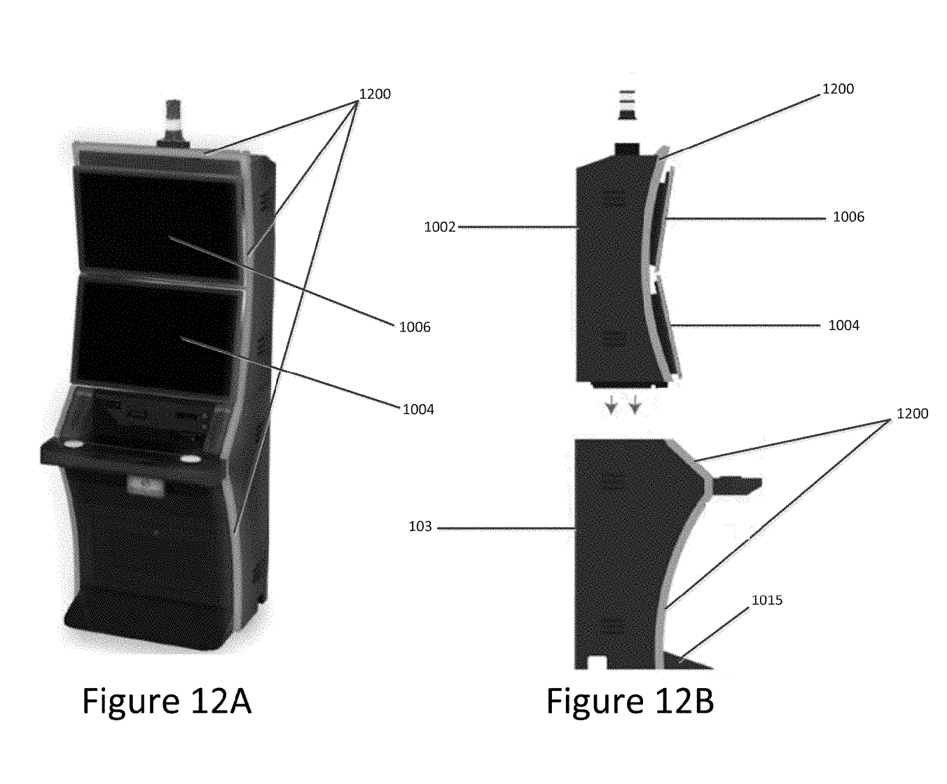

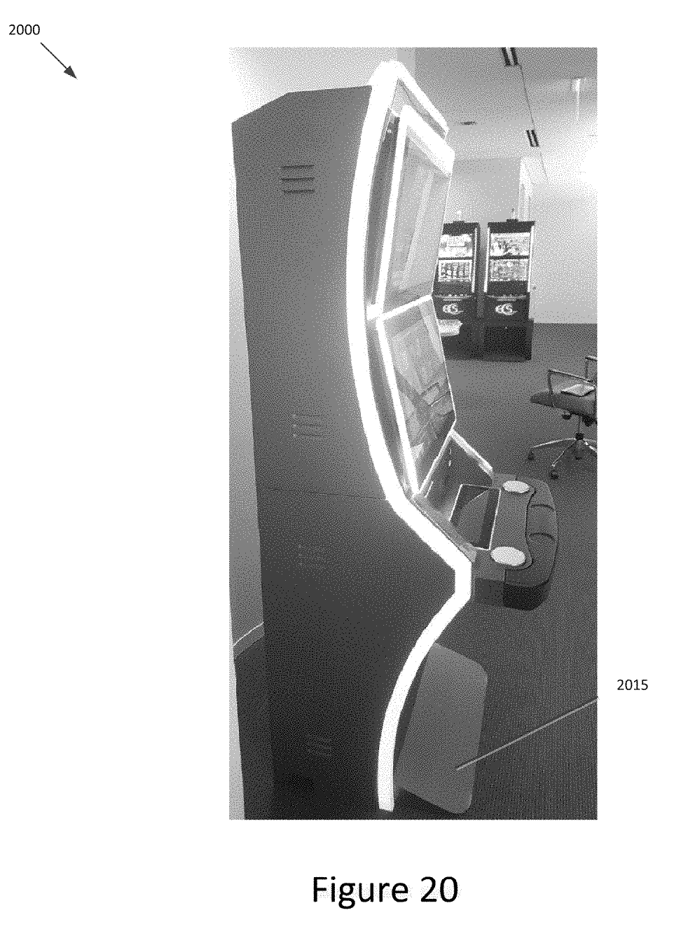

FIGS. 10A and 10B illustrate perspective views of one embodiment of a modular gaming system 1000 having an upper modular cabinet 1002 with dual display monitors 1004 and 1006. As depicted in FIGS. 10A and 13, upper modular cabinet 1002 is configured to hold two display monitors 1004 and 1006, wherein upper monitor 1006 is held above lower monitor 1004 by door 1304 in a closed position. FIGS. 11A and 11B illustrate the modularity of the design of the modular gaming system 1000 depicted in FIGS. 10A and 10B. As seen in FIGS. 11A and 11B, an upper cabinet 1002 holds two display monitors 1004 and 1006, instead of one display monitor, and is interchangeably mounted onto base cabinet 103. FIG. 12A illustrates a perspective view of the modular gaming system 100 having an upper modular cabinet 1002 with dual display monitors 1004 and 1006, according to one embodiment of the present invention, including lighting panels 1200 shown in front and side views. FIG. 12B illustrates a side view of the modular gaming system depicted in FIG. 12A, including lighting panels 1200. FIG. 20 illustrates a side view of the modular gaming system of FIG. 18, according to another embodiment, including a cushioned footrest 2015.

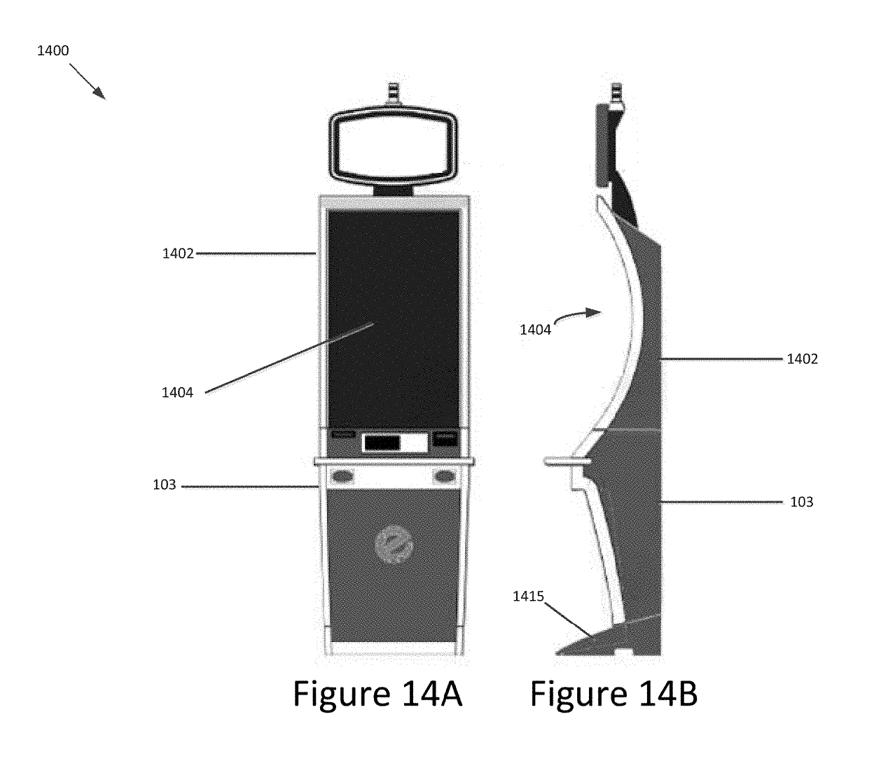

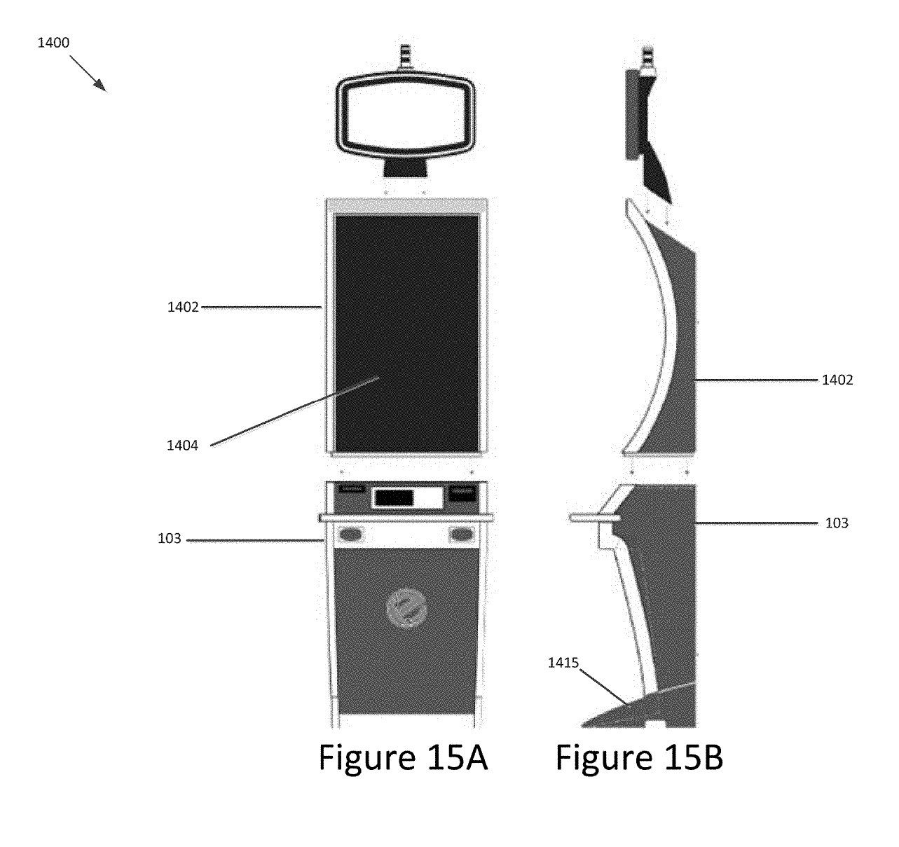

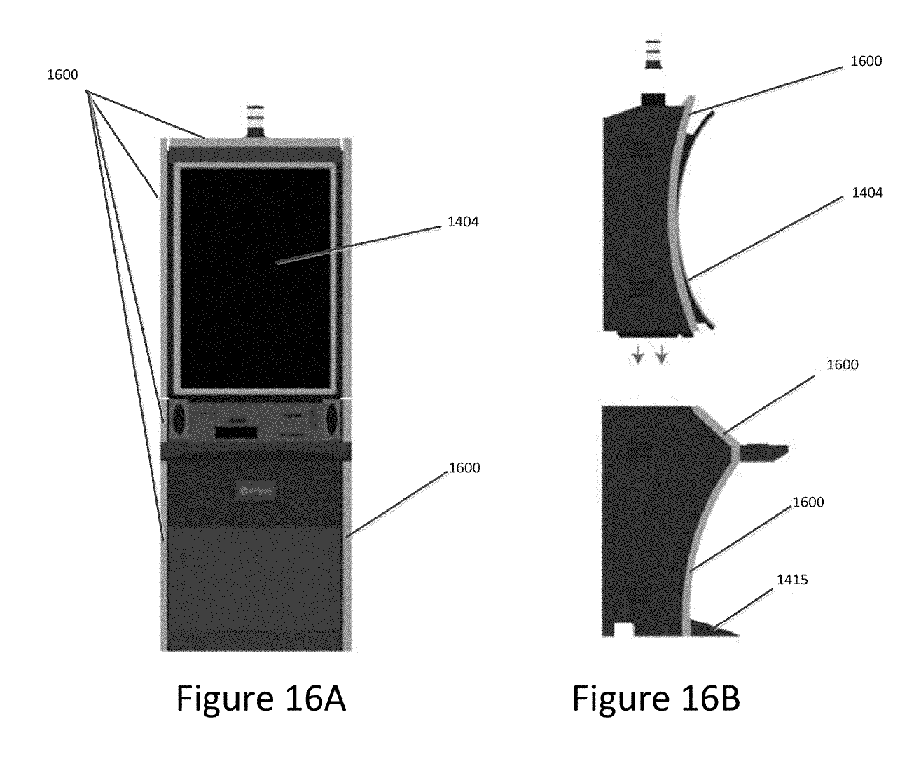

FIGS. 14A and 14B illustrate perspective views of one embodiment of the modular gaming system 1400 having an upper modular cabinet 1402 holding a curved display monitor 1404. FIG. 14B is an illustration of a side view of the modular gaming system 1400 depicted in FIG. 14A. As seen in 14B, a curved display monitor 1404 is housed by a curved upper modular cabinet 1402. FIGS. 15A and 15B illustrate the modularity of the design of the modular gaming system 1400 illustrated in FIGS. 14A and 14B. According to a preferred embodiment of the invention, curved upper modular cabinet 1402 may be removeably attached at a seam 150 to the top end of base cabinet 103. Additionally, curved upper modular cabinet 1402 may be interchangeably attached by dual monitor upper modular cabinet 1002, single monitor upper modular cabinet 702, or table top 310 to base cabinet 103. FIGS. 16A and 16B illustrate perspective views of the modular gaming system 1400 having an upper modular cabinet with a curved display monitor, according to another embodiment of the present invention, including lighting units 1600.

FIG. 17 illustrates one embodiment of a mounting configuration for display monitors housed by an upper modular cabinet of the modular gaming system. As seen in FIG. 17, one or more mounting brackets 1702 may be constructed into a door 1706 of upper modular cabinet 1002 for mounting display units. Any extra cords or wires stemming from or plugging into display units mounted by upper cabinet 1002, e.g. display units 1004 and 1006 as illustrated in FIGS. 12A and 12B, are fed through holes 1704 and housed in the interior area of the upper modular cabinet 1002 behind the door 1706.

One of ordinary skill in the art will appreciate that not all modular gaming systems have all of these components and may have other components in addition to, or in lieu of, those components mentioned here. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A modular gaming console, the console comprising:
a base cabinet including a plurality of support members, the support members including a front face member, a back face member, a first side face member, a second side face member, the base cabinet housing gaming system components, the base cabinet including a first door forming a portion of the front face member, the first door moveable between an open position and a closed position, the first door including user gaming interface components;
a footrest at the base cabinet, the footrest extending from a lower portion of the front face member; and
an upper modular cabinet removeably attached at a seam to a top end of the base cabinet, the upper modular cabinet configured to hold at least one display monitor, the upper modular cabinet including a pivot, the pivot for pivotally attaching a second door to the upper modular cabinet, the second door for holding the at least one display monitor, the second door being moveable about the pivot between an open position and a closed position, the second door providing user viewing access to the at least one display monitor.

2. The console of claim 1, wherein the gaming system components include two or more of a central processing unit (CPU), a printer, a speaker, a subwoofer, a battery backup, power supply, or a bill acceptor.

3. The console of claim 1, wherein the gaming interface components include at least two of a speaker, a mechanical button, a video button panel, an LED controller, or an audio amplifier.

4. The console of claim 1, further comprising a back plate, the back plate configured to cover the back face member of the base cabinet.

5. The console of claim 1, wherein the footrest is cushioned.

6. The console of claim 1, wherein the first door provides access to the gaming system components in the open position.

7. The console of claim 1, wherein the first door provides access to the user gaming interface components in the closed position.

8. The console of claim 1, wherein the second door provides user viewing access to the at least one display monitor in the closed position.

9. The console of claim 1, wherein the upper modular cabinet is configured to hold two display monitors, wherein an upper monitor is held above a lower monitor by the second door in a closed position.

10. The console of claim 1, wherein the upper modular cabinet has a curved shape to hold a curved display monitor of the at least one display monitor.

11. The console of claim 1, wherein the second door is moveable about the pivot in a vertical direction to open and close the second door.

12. The console of claim 1, wherein the at least one display monitor includes at least one of a computer monitor, a gaming monitor, a television monitor, a liquid crystal display (LCD) monitor, an light-emitting diodes (LEDs) display monitor, an in-plane switching display monitor, or a high-definition (HD) display monitor.

13. The console of claim 1, wherein the upper modular cabinet comprises a front panel and a side panel, the front panel and the side panel include lighting units.

14. The console of claim 13, wherein the lighting units include light emitting diodes (LEDs).

15. The console of claim 1, wherein the upper modular cabinet is positioned in a horizontal direction, wherein the at least one display monitor is configured as a table top, wherein a screen of the at least one display monitor faces an upward direction, and the screen is touchscreen.

16. The console of claim 1, wherein the upper modular cabinet and the base cabinet includes at least one cabinet finish including a powder coat, a vinyl wrap, a magnetic wrap, and a color.

17. The console of claim 1, wherein the base cabinet may include two or more of a player tracking module, a logo displayed on the front face member, a button deck LCD, a marketing display, or a cabinet back lit panel.

18. The console of claim 1, further comprising a backlight marquee attached to a top portion of the upper modular cabinet, the backlight marquee including an LED backlight.

19. The console of claim 1, wherein the at least one display monitor includes a touchscreen.

20. A modular gaming system, the system comprising:
a base cabinet including a plurality of support members, the support members including a front face member, a back face member, a first side face member, a second side face member, the base cabinet housing gaming system components, the base cabinet including a first door forming a portion of the front face member, the first door moveable between an open position and a closed position, the first door including user gaming interface components;
a footrest at the base cabinet, the footrest extending from a lower portion of the front face member; and
at least two upper modular cabinets, each upper modular cabinet being capable of being interchangeably attached at a seam to a top end of the base cabinet, the at least two upper modular cabinets configured to hold at least one display monitor, the at least two upper modular cabinets including a pivot, the pivot for pivotally attaching a second door to the at least two upper modular cabinets, the second door for holding the at least one display monitor, the second door being moveable about the pivot between an open position and a closed position, the second door providing user viewing access to the at least one display monitor.

21. The modular gaming system of claim 20, wherein the base cabinet is built to one of several heights.
